(19) United States
(12) Patent Application Publication
(10) Pub. No.: US 2005/0223287 A1
(43) Pub. Date: Oct. 6, 2005

(54) Presence-based system management information routing system

(75) Inventors: Rhonda L. Childress, Austin, TX (US); Ward K. Harold, Austin, TX (US); David Bruce Kumhyr, Austin, TX (US); Neil Raymond Pennell, Cedar Creek, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/809,584

(22) Filed: Mar. 25, 2004

(51) Int. Cl. G06F 11/00

(52) U.S. Cl. 714/26

(57) ABSTRACT

A system, method and computer instructions are disclosed for routing system management information to entities or parties who are responsible for responding to the management information. If a management agent or managed resource associated with a computer-based management system desires to send event or notification information to an entity, party or person responsible for responding to the event or notification information, the management agent or managed resource can determine an identity of an entity, party or person responsible for responding to the event or notification from a prioritized “on-call list”. The management agent or managed resource can then determine the availability of the identified entity, party or person from a Presence Network, and send the event or notification information to a resource where the identified entity, party or person is currently “present”. The presence information obtained from the Presence Network can be used by the management agent or managed resource to determine which of the responsible entities, parties or persons are available at run-time. The management agent or managed resource can then forward the event or notification information to the most appropriate responsible entity, party or person.

### BACKGROUND OF THE INVENTION

1. Technical Field

The present invention relates generally to improved computer system management, and in particular, but not exclusively, to a system and method for routing system management information to an intended recipient based on presence awareness or the availability of the intended recipient.

2. Description of Related Art

Management agents and/or managed resources in computer-based management systems typically send event information to system administrators in order to notify the administrators about the occurrence of critical failures or to periodically deliver summary statistics. In most of the existing management system environments, these events/notifications are typically directed to a centralized entity in the management system. The effectiveness of the management response to the event, and in particular to the critical failure information, depends to a great extent on the parties responsible for responding to the incoming event information having adequate access or connectivity to the centralized entity. However, the access or connectivity to the centralized entity needed by these responsible parties may not be available in certain situations because of computer network restrictions or client software requirements, to name a few. Therefore, it would be advantageous to have an improved system and method for routing system management information, and in particular, but not exclusively, for routing event or notification information to those parties responsible for responding to the events or notifications involved.

### SUMMARY OF THE INVENTION

The present invention provides a system, method and computer instructions for routing system management information to entities, parties or persons who are responsible for responding to the management information. If a management agent or managed resource associated with a computer-based management system desires to send event or notification information to an entity, party or person responsible for responding to the event or notification information, the management agent or managed resource can determine an identity of an entity, party or person responsible for responding to the event or notification from a prioritized “on-call list”. The management agent or managed resource can then determine the availability of the identified entity, party or person from a Presence Network, and send the event or notification information to a resource where the identified entity, party or person is currently “present”. The presence information obtained from the Presence Network can be used by the management agent or managed resource to determine which of the responsible entities, parties or persons are available at run-time. The management agent or managed resource can then forward the event or notification information to the most appropriate responsible entity, party or person.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram of a data processing system that may be implemented as a client in accordance with a preferred embodiment of the present invention; and

FIG. 4 depicts a pictorial representation of a system for routing system management information, such as event or notification information, which may be implemented in accordance with a preferred embodiment of the present invention.

### DETAILED DESCRIPTION OF THE PREFERRED EMBODIMENT

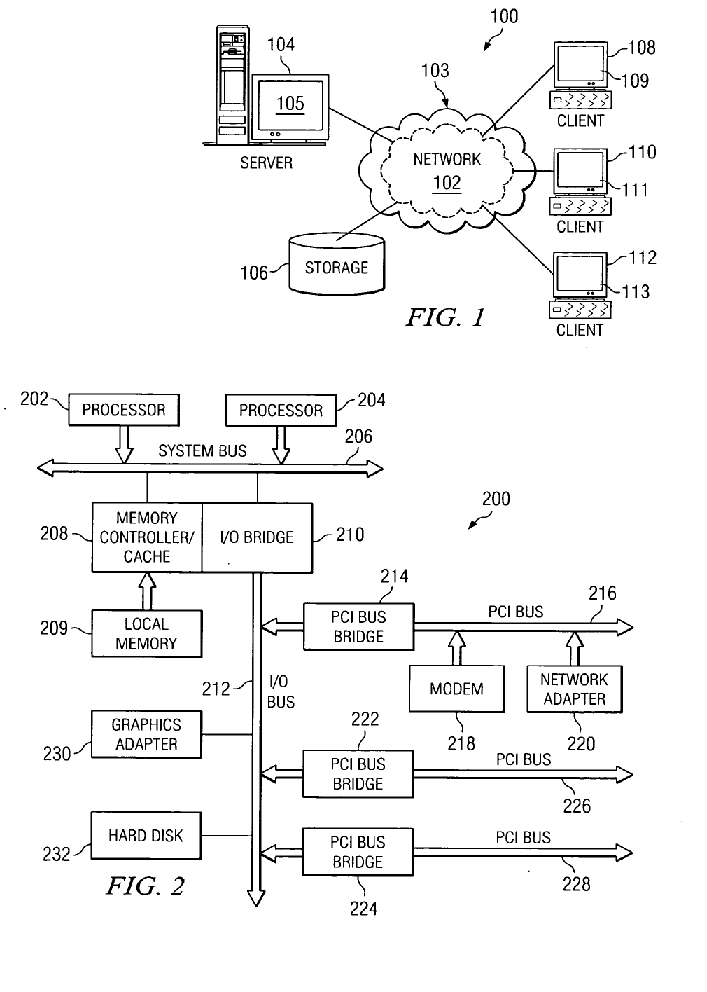

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is a medium used to provide communications links between various devices and computers connected together within network data processing system 100; Network 102 may include certain connections, such as wire, wireless communication links, or fiber optic cables. In accordance with a preferred embodiment of the present invention, network 100 can represent and/or include “Presence Network” 103, which is a medium used to provide presence or availability information about selected entities, parties or persons in order to ensure that certain system management information, such as, for example, event or notification information, is routed to an appropriate entity, party or person responsible for responding to the system management information involved. As such, a novel system for routing system management information (e.g., event or notification information) to a responsible entity, party or person is described below with respect to FIG. 4.

In the depicted example, server 104 is connected to network 102. Server 104 provides access to storage unit 106 for clients 108, 110, 112. Server 104 can include a monitor 105 for displaying resources associated with server 104. In addition, clients 108, 110, and 112 are connected to network 102. These clients 108, 110, and 112 may be, for example, personal computers or network computers. Clients 108, 110, 112 can include respective monitors 109, 111, 113 for displaying resources associated with clients 108, 110, 112. In the depicted example, server 104 may provide data, such as boot files, Operating System (OS) images, and applications to clients 108, 110, and 112. Clients 108, 110 and 112 are clients with respect to server 104. Network data processing system 100 may include additional servers, clients, and other devices not shown.

Server 104 can provide data from storage unit 106. Data from storage unit 106 can include Web pages. The Web pages may be, for example, HyperText Markup Language (HTML) documents. For this exemplary embodiment, the Web pages can be different, dynamic Web pages with, for example, Active Server Page (ASP) code embedded therein, a Java applet associated therewith, and/or a Java Script embedded therein.

In the depicted example, network data processing system 100 can be the Internet, with network 102 representing a worldwide collection of networks and gateways that use the known Transmission Control Protocol/Internet Protocol (TCP/IP) suite of protocols to communicate with one another. At the heart of the Internet is a backbone of high-speed data communication lines between major nodes or host computers, including thousands of commercial, government, educational and other computer systems that route data and messages. Of course, network data processing system 100 also may be implemented as a number of different types of networks, such as, for example, an intranet, internal network, Local Area Network (LAN), or Wide Area Network (WAN). In this regard, FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, data processing system 200 may be a single processor system. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated, or separately configured as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108, 110, 112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly. Data processing system 200 can include a monitor, such as, for example, monitor 105 in FIG. 1 for displaying resources of data processing system 200.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

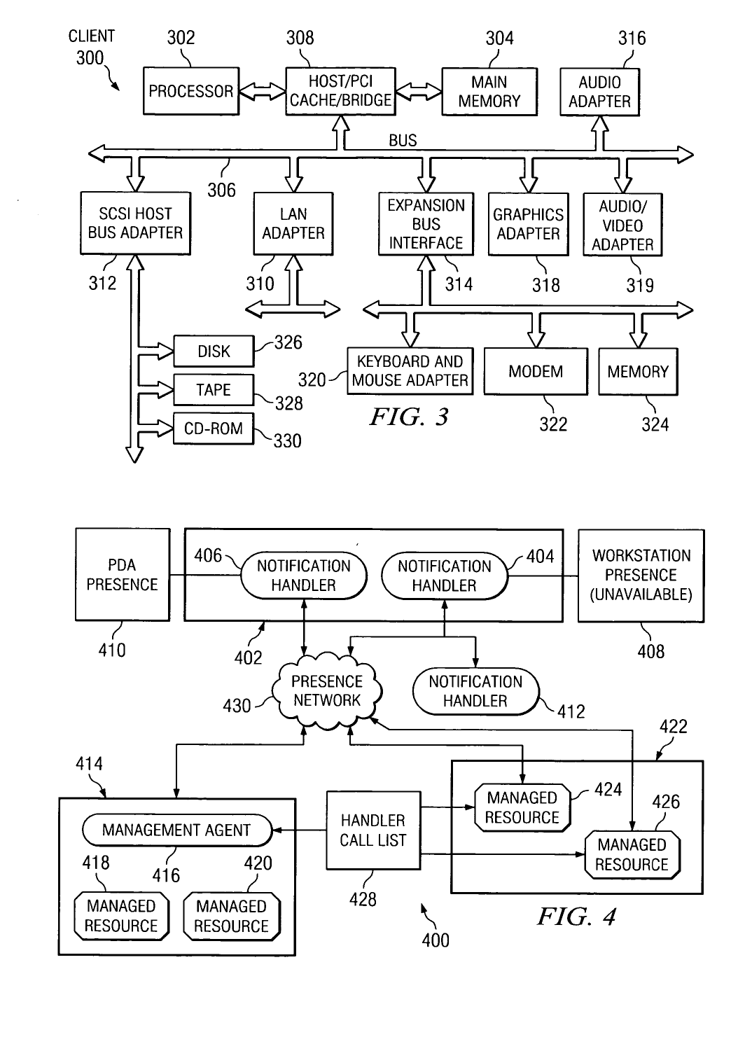

With reference now to FIG. 3, a block diagram of a data processing system that may be implemented as a client, such as one or more of clients 108, 110, 112 in FIG. 1, is depicted in accordance with a preferred embodiment of the present invention. For example, data processing system 300 in FIG. 3 can be a client processing unit, computer, workstation, Personal Digital Assistant (PDA), etc. As shown, data processing system 300 can employ a PCI local bus architecture. However, although the depicted example employs a PCI bus, other bus architectures such as, for example, Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, LAN adapter 310, Small Computer System Interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors. Data processing system 300 can include a monitor, such as, for example, one of monitors 109, 111, 113 in FIG. 1 for displaying resources of data processing system 300.

An OS runs on processor 302 and is used to coordinate and provide control of various components within data processing system 300 in FIG. 3. The OS may be a commercially available OS, such as Windows XP or Windows 2000, which are available from Microsoft Corporation. Also, for example, an object-oriented programming system such as Java may run in conjunction with the OS and provide calls to the OS from Java programs or applications executing on data processing system 300. “Java” is a trademark of Sun Microsystems, Inc. Instructions for the OS, the object-oriented OS, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 includes some type of network communication interface. As a further example, data processing system 300 may be a PDA or similar device, which is configured with ROM and/or flash ROM in order to provide non-volatile memory for storing OS files and/or user-generated data.

The depicted example in FIG. 3 and above-described examples are not meant to imply architectural limitations on the present invention. For example, data processing system 300 also may be a notebook computer or hand-held computer in addition to taking the form of a PDA. Also, data processing system 300 may be a kiosk or a Web appliance.

FIG. 4 depicts a pictorial representation of a system for routing system management information, such as event or notification information, which may be implemented in accordance with a preferred embodiment of the present invention. For this exemplary embodiment, system 400 includes responsible entity 402. Entity 402 represents an entity, party or person having the responsibility of responding to the system management information received. For example, an entity responsible for responding to the system management information may be automated or human. The system management information can be conveyed in message or report form and include text, voice or video information related, for example, to the occurrence of an event (e.g., critical failure of a system component), notification information related to an event, and/or system administrative information. In other words, the present invention enhances the routing of the system management information to ensure that the system management information effectively reaches an intended recipient, such as an entity, party or person having responsibility for responding to the system management information.

Entity 402 is associated with notification handlers 404, 406. For this exemplary embodiment, notification handler 404 is preferably an Instant Messaging client (e.g., software application) running on workstation 408 and associated with entity 402. Notification handler 404 and workstation 408 can be implemented, for example, by client 108, 110 or 112 in FIG. 1. Notification handler 406 is preferably an Instant Messaging client running on PDA 410. Notification handler 406 can also be implemented on a server (e.g., server 104 in FIG. 1) connected, for example, via a wireless network to PDA 410. As such, the content of the event or notification information message or report received by notification handler 404 and workstation 408 can be in text, video and/or digitized audio form. The content of the event or notification message or report received by notification handler 406 and PDA 410 is typically in text form (e.g., limited in this regard by the processing capability of PDA 410).

Although not shown explicitly in FIG. 4, entity 402 can also include other notification handlers associated with other types of telecommunication media for receiving and responding to the system management information involved, such as, for example, cellular phones (e.g., using the Wireless Application Protocol or WAP to convey textual or digitized audio information), satellite communication radiotelephones, etc. In any event, a notification handler (e.g., notification handler 404, 406) can receive system management information via an Instant Message, and if necessary, convert the system management information received in Instant Message form to a form that is appropriate for the resource (e.g., workstation, PDA, cellular telephone, radiotelephone, notebook computer, hand-held computer, etc.) that provides “presence” or availability information about the intended recipient or entity. For illustrative purposes, notification handler 412 is also shown in order to indicate that additional entities, parties or persons responsible for responding to system management information may also be intended recipients for such information. For example, notification handler 412 can function as a default responsible entity, which provides a “canned” response to received system management information. In this regard, the depicted examples of notification handlers and entities/resources in FIG. 4 are not meant to imply architectural limitations on the present invention.

Notification handlers 404, 406 and 412 are connected to Presence Network 430. For this embodiment, Presence Network 430 preferably includes an Instant Messaging network that provides network “presence” information and Instant Messaging services, such as, for example, Yahoo's Instant Messaging services or Microsoft Network's (MSN's) Instant Messaging services. Presence Network 430 can operate in accordance with known “presence” and instant messaging protocols, such as, for example, the Session Initiation Protocol (SIP), the SIP for Instant Messaging and Presence Leverage Extensions (SIMPLE), and the XML-based Extensible Messaging and Presence Protocol (XMPP). Presence Network 430 can also derive network “presence” or availability information using, for example, the Hotsip Presence Engine produced by Hotsip AB at Stockholm, Sweden. The Hotsip Presence Engine is a SIP/SIMPLE-based back-end server system that can aggregate real-time presence information such as a person's availability, terminal status, location, current activity and mood. A server collects presence information from different SIP clients and other systems. The aggregated information is then provided for presence, messaging, voice and video services. The Hotsip Presence Engine can run on J2EE and with LINUX and AIX OS's.

As illustrated in FIG. 1, Presence Network 430 functions as an overlay over the underlying network(s) (e.g., network 102 in FIG. 1) that provide connectivity for routing system management information to the appropriate notification handler and entity/resource involved. Also, Presence Network 430 provides “presence” information (e.g., “presence” and/or availability of one or more of the entities, parties or persons associated with notification handlers 404, 406, 412) for use by one or more of management agent 416 and managed resources 418, 420 of management unit 414, and managed resources 424, 426 of management unit 422. For example, management agent 416 can include a management service application that monitors or manages a managed resource (e.g., managed resources 418, 420). Therefore, management agent 416 can derive system management information (e.g., critical failure, notification information, etc.) from one or both of managed resources 418, 420. Also, each managed resource (e.g., each of managed resources 418, 420, 424, 426) can generate system management information independently of management agent 416. Each managed resource 418, 420, 424, 426 can be, for example, an OS (e.g., Linux, AIX, etc.), J2EE container, or similar network software or hardware resource.

Management agent 416 and each of managed resources 424, 426 are connected to handler call list 428. For this embodiment, handler call list 428 is preferably an “on-call list” that resides in a database or similar data storage location (e.g., storage unit 106 in FIG. 1). The “on-call list” includes identification information for each of the entities, parties or persons responsible for responding to the system management information derived or generated by management agent 416 and managed resources 418, 420, 424, 426. The “on-call list” may be static (e.g., a file or property list) or dynamic (e.g., a result of a database query or directory lookup).

When management agent 416 or one of managed resources 418, 420, 424, 426 desires to send out a message or report related to an event or notification, the management agent or managed resource consults the “on-call list” (e.g., handler call list 428) and retrieves the stored identification information including an address for the respective notification handler(s) associated with the retrieved identity information. The management agent or managed resource then determines from Presence Network 430 the “presence” or availability of the resource (e.g., workstation 408, PDA 410) associated with the responsible entity, party or person intended as a recipient of the event or notification information. The management agent or managed resource then forwards the event or notification message or report to the appropriate notification handler(s) associated with the intended recipient(s) of the event or notification information via an Instant Message. The payload of the Instant Message may be tailored to the format of the intended recipient's resource (e.g., workstation, PDA, cellular phone, etc.) that is providing the “presence” for the selected entity, party or person involved. As illustrated in FIG. 4, Presence Network 430 can determine that workstation 408 is unavailable to receive the system management information, and PDA 410 is available. Thus, the management agent or managed resource can forward the event or notification message or report to the intended recipient via PDA 410.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A data processing system for routing system management information, comprising:
a plurality of notification units;
a network coupled to said plurality of notification units, said network operable to determine whether each notification unit of said plurality of notification units is available to receive system management information; and
a plurality of management units coupled to said network, at least one management unit of said plurality of management units operable to:
generate said system management information;
determine an identity of an intended recipient for said system management information;
associate said identity with at least one notification unit of said plurality of notification units; and
determine whether said at least one notification unit is available to receive said system management information.

2. The data processing system of claim 1, wherein said at least one management unit is further operable to send said system management information to said at least one notification unit via an instant message if said at least one notification unit is available to receive said system management information.

3. The data processing system of claim 1, wherein said network comprises a presence network.

4. The data processing system of claim 1, wherein said network comprises an instant messaging network.

5. The data processing system of claim 1, wherein said at least one notification unit comprises an instant messaging client associated with said intended recipient.

6. The data processing system of claim 1, wherein said at least one management unit comprises at least one of a management agent and a managed resource.

7. The data processing system of claim 1, wherein said system management information comprises event information or notification information.

8. The data processing system of claim 1, wherein said intended recipient comprises at least one of an entity, party and person having a responsibility for responding to said system management information.

9. The data processing system of claim 1, wherein the operation to determine said identity comprises an operation to access an on-call list of responsible entities, parties or persons.

10. A method in a data processing system for routing system management information, the method comprising the steps of:
coupling a network to a plurality of notification units;
said network determining whether each notification unit of said plurality of notification units is available to receive system management information;
coupling a plurality of management units to said network; and
at least one management unit of said plurality of management units generating said system management information, determining an identity of an intended recipient for said system management information, associating said identity with at least one notification unit of said plurality of notification units, and determining whether said at least one notification unit is available to receive said system management information.

11. The method of claim 10, further comprising the step of said at least one management unit sending said system management information to said at least one notification unit via an instant message if said at least one notification unit is available to receive said system management information.

12. The method of claim 10, wherein said network comprises a presence network.

13. The method of claim 10, wherein said network comprises an instant messaging network.

14. The method of claim 10, wherein said at least one notification unit comprises an instant messaging client associated with said intended recipient.

15. The method of claim 10, wherein said at least one management unit comprises at least one of a management agent and a managed resource.

16. The method of claim 10, wherein said system management information comprises event information or notification information.

17. The method of claim 10, wherein said intended recipient comprises at least one of an entity, party and person having a responsibility for responding to said system management information.

18. The method of claim 10, wherein the step to determine said identity comprises accessing an on-call list of responsible entities, parties or persons.

19. A computer program product in a computer-readable medium for routing system management information, the computer program product comprising:
first instructions for coupling a network to a plurality of notification units;
second instructions for determining whether each notification unit of said plurality of notification units is available to receive system management information;
third instructions for coupling a plurality of management units to said network;
fourth instructions for generating said system management information;
fifth instructions for determining an identity of an intended recipient for said system management information;
sixth instructions for associating said identity with at least one notification unit of said plurality of notification units; and
seventh instructions for determining whether said at least one notification unit is available to receive said system management information.

20. The computer program product of claim 19, further comprising:
eighth instructions for sending said system management information to said at least one notification unit via an instant message if said at least one notification unit is available to receive said system management information.
